(19) United States
(12) Patent Application Publication
(10) Pub. No.: US 2006/0254271 A1
(43) Pub. Date: Nov. 16, 2006

(54) Apparatus for controlling microwave reflecting

(75) Inventors: Kuniyuki Imanari, Tokyo (JP); Ryuki Nohara, Tokyo (JP); Ikuhisa Mizuta, Tokyo (JP); Takeshi Murooka, Tokyo (JP)

Correspondence Address: GRIFFIN & SZIPL, PC, SUITE PH-1, 2300 NINTH STREET, SOUTH, ARLINGTON, VA, 22204, US

(73) Assignee: Ishikawajima-Harima Heavy Industries Co., Ltd., Chiyoda-ku (JP)

(21) Appl. No.: 11/128,411

(22) Filed: May 13, 2005

(51) Int. Cl. F02B 33/44

(52) U.S. Cl. 60/598

(57) ABSTRACT

A microwave reflection control device of the present invention comprises a reflection member which divides the inside of an inlet duct of a gas turbine engine into a plurality of areas in a peripheral or radial direction with respect to a duct center axis. The reflection member is formed into a reflection curved surface shape to block and diffuse a microwave which comes toward a fan moving blade from the inlet duct. Thus, reflection of the microwave by the fan moving blade is suppressed.

### BACKGROUND OF THE INVENTION

1. Technical Field of the Invention

The present invention relates to an apparatus for suppressing reflection of a microwave by an inlet fan moving blade of a turbofan engine.

2. Description of the Related Art

In some aircrafts such as fighters, stealthiness is required on their airframes to strategically prevent their appearance on a radar. Accordingly, the stealthiness has been improved by contriving shapes of airframe surfaces or adding radio wave absorbers.

While contrivance of the airframes has progressed, various investigations have been made with respect to reflection of a microwave from each engine main body. An engine side face of aircraft is usually covered into an airframe surface shape to improve stealthiness. Therefore, a microwave that enters the engine though a duct to be reflected poses a particular problem.

FIG. 1 is a partial sectional view of a duct shape of a turbofan engine according to a conventional art. FIG. 2 is a sectional view cut on the line B-B of FIG. 1. As shown in FIGS. 1 and 2, a duct member 21 of the turbofan engine is usually connected through a strut 24, a vane 26, and the like to a fan moving blade 23. When the engine stops, a microwave that enters from a duct inlet is frequently reflected irregularly by a curved surface part of the fan moving blade 23 to be attenuated. After a start of the engine, however, the rotating fan moving blade 23 becomes a reflection plane to directly reflect the microwave that has entered the duct.

Thus, according to the conventional art, as described in Patent Document 1, the microwave has been obliquely reflected on a duct inner curved surface by bending an air intake duct (intake) shape and visually shielding the fan moving blade. In other words, the microwave that has entered the fan moving blade 23 is blocked and diffused by the curved surface, thereby suppressing reflection of the microwave.

However, this duct shape leads to separation of intake air during supersonic flight, causing nonuniform pressure distribution in the duct. Thus, an operation range of the engine is reduced, imposing a great limit on an aircraft operation. According to this prior art, therefore, as shown in FIG. 3, to suppress air separation, air suction is carried out through the duct by a compressor 28.

According to Patent Document 2, air separation is suppressed during supersonic flight by disposing a slowly changed long duct, whereby both of suppression of microwave reflection and limitation of an aircraft operation are realized.

Furthermore, according to Patent Document 3, a cavity having a radio wave absorber therein is formed on a front face of a duct, intending to provide similar effects.

In these prior arts, however, there have been problems of a necessity of special means for sucking air from the duct, a necessity of a very long duct, and an increase in weight to limit functions of the airframe caused by mounting of the radio wave absorber, thereby imposing constraints on shape design of the entire airframe.

[Patent Document 1]

U.S. Pat. No. 4,989,807

[Patent Document 2]

U.S. Pat. No. 5,683,061

[Patent Document 3]

U.S. Pat. No. 4,148,032

### SUMMARY OF THE INVENTION

It is an object of the present invention to increase a range of an aircraft operation by suppressing reflection of a microwave to limit an influence on an operation range of an engine without adding any great changes to an outer shape of an air intake duct as in the case of the conventional art.

To achieve the object, according to a first aspect of the present invention, there is provided an apparatus for controlling microwave reflecting comprising a reflection member which divides the inside of an inlet duct of a gas turbine engine into a plurality of areas in a peripheral or radial direction with respect to a duct center axis, wherein the reflection member is formed into a reflection curved surface shape to block and diffuse a microwave which comes toward a fan moving blade from the inlet duct, thereby suppressing reflection of the microwave by the fan moving blade.

According to the first aspect of the present invention, without changing an outer peripheral shape of the inlet duct, the entry of the microwave to the fan moving blade is blocked by a reflection curved surface comprising a plurality of curved surfaces in which a shape of a structure in a front end of the fan moving blade is contrived, whereby the reflection of the microwave can be prevented. Moreover, the microwave is obliquely reflected with respect to an advancing direction, and then scattered in the duct to be attenuated. Different from the conventional case of obtaining similar effects by bending the duct, an influence on an air flow in the duct can be limited low. Thus, pressure distribution of flowing-in air can be maintained uniform, and an influence on engine performance can be limited low.

A second aspect of the present invention is a preferred embodiment of the first aspect, wherein the reflection member comprises a plurality of struts which are mounted in the inlet duct and radially extended around a duct center.

According to the second aspect of the present invention, without changing an outer peripheral shape of the inlet duct, the entry of the microwave to the fan moving blade is blocked by a reflection curved surface formed by contriving shapes of a plurality of struts, whereby the reflection of the microwave can be prevented. Moreover, the microwave is obliquely reflected with respect to an advancing direction, and then scattered in the duct to be attenuated. It is to be noted that the strut is originally a structural member to support a nose cone or the like. Different from the conventional case of obtaining similar effects by using the duct shape, an influence on an air flow in the duct can be limited low. Thus, pressure distribution of flowing-in air can be maintained more uniform, whereby an influence on engine performance can be limited low.

A third aspect of the present invention is a preferred embodiment of the first aspect, further comprising a plurality of struts which are mounted in the inlet duct and radially extended from near a duct center, wherein the reflection member comprises a plurality of peripheral guide vanes which are mounted to the struts and which extend in the peripheral direction with respect to the duct center axis and which are concentrically arranged at intervals in a radial direction.

According to the third aspect of the present invention, without bending the inlet duct, the entry of the microwave to the fan moving blade is blocked by a reflection curved surface formed by contriving shapes of a plurality of peripheral guide vanes, whereby the reflection of the microwave can be prevented. Moreover, the microwave is obliquely reflected with respect to an advancing direction, and then scattered in the duct to be attenuated. It is to be noted that the peripheral guide vane is originally a mechanism of optimally maintaining a flowing-in direction, a flow velocity, and pressure of air flowing to the fan moving blade. Different from the conventional case of obtaining similar effects by bending the duct, an influence on an air flow in the duct can be limited low. Thus, pressure distribution of the flowing-in air can be maintained more uniform, whereby an influence on engine performance can be limited low.

A fourth aspect of the present invention is a preferred embodiment of the first aspect, further comprising a duct member to define the inlet duct, wherein an inner peripheral part of the duct member is formed into a shape along a surface shape of a diameter outside of a peripheral guide vane positioned in an outermost diameter side among the plurality of peripheral guide vanes.

According to the fourth aspect of the present invention, an entry sectional area of the microwave of the fan moving blade is reduced by forming the inner peripheral part of the duct member into the shape along the surface shape of the diameter outside of the peripheral guide vane positioned in the outermost diameter side, whereby the reflection of the microwave can be prevented. In other words, entry of the microwave into the duct member by forming the inner peripheral part into the shape along the shape of the peripheral guide vane, and even the microwave that has entered is blocked and diffused by the peripheral guide vane, whereby the reflection of the microwave can be suppressed.

A fifth aspect of the present invention is a preferred embodiment of the first aspect, further comprising a movable guide vane mounted to a rear end part of the strut to swing around an axial center of the radial direction.

A sixth aspect of the present invention is a preferred embodiment of the second aspect, further comprising a movable guide vane mounted to a rear end part of the strut to swing around an axial center of the radial direction.

A seventh aspect of the present invention is a preferred embodiment of the third aspect, further comprising a movable guide vane mounted to a rear end part of the strut to swing around an axial center of the radial direction.

An eighth aspect of the present invention is a preferred embodiment of the fourth aspect, further comprising a movable guide vane mounted to a rear end part of the strut to swing around an axial center of the radial direction.

According to the fifth to eighth aspects of the present invention, especially when the movable guide vane is closed at the time of low engine thrust, the entry of the microwave to the fan moving blade can be suppressed more. In other words, by microwave reflection of the movable guide vane itself, it is possible to obtain an effect of suppressing the microwave reflection more together with the other configurations.

A ninth aspect of the present invention is a preferred embodiment of the first aspect, wherein a surface of the reflection member is made of a radio wave absorber.

According to the ninth aspect of the present invention, the microwave that has entered the reflection member is absorbed to a certain extent by the radio wave absorber. Thus, it is possible to obtain an effect of suppressing the reflection of the microwave more.

Other objects and advantageous features of the present invention will become apparent upon reading of the following description made with reference to the accompanying drawings.

### BRIEF DESCRIPTION OF THE DRAWINGS

FIG. 1 is a view illustrating a conventional art;

FIG. 2 is a sectional view cut on the line B-B of FIG. 1;

FIG. 3 is a view illustrating a conventional art;

FIG. 4 is a view showing a configuration of a first embodiment of the present invention;

FIG. 5 is a sectional view cut on the line A-A of FIG. 4;

FIG. 6 is a view showing a configuration of a second embodiment of the present invention; and

FIG. 7 is a view showing a configuration of a third embodiment of the present invention.

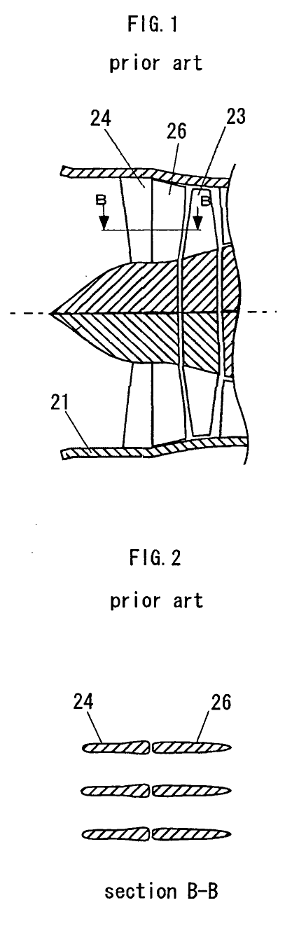

### DESCRIPTION OF THE PREFERRED EMBODIMENTS

First to third embodiments of the present invention will be described in detail with reference to the accompanying drawings. Throughout the drawings, similar portions will be denoted by similar reference numerals, and repeated explanation will be avoided.

FIG. 4 is a partial sectional view of a turbofan engine 10 which comprises an apparatus for controlling microwave reflecting according to the first embodiment of the present invention. Referring to FIG. 4, a reference numeral 1 denotes a duct member to define an inlet duct, a reference numeral 7 denotes a center support member positioned in a center of the inlet duct, a reference numeral 4 denotes a strut to connect the duct member 1 to the center support member 7, a reference numeral 6 denotes a movable guide vane, and a reference numeral 3 denotes a fan moving blade.

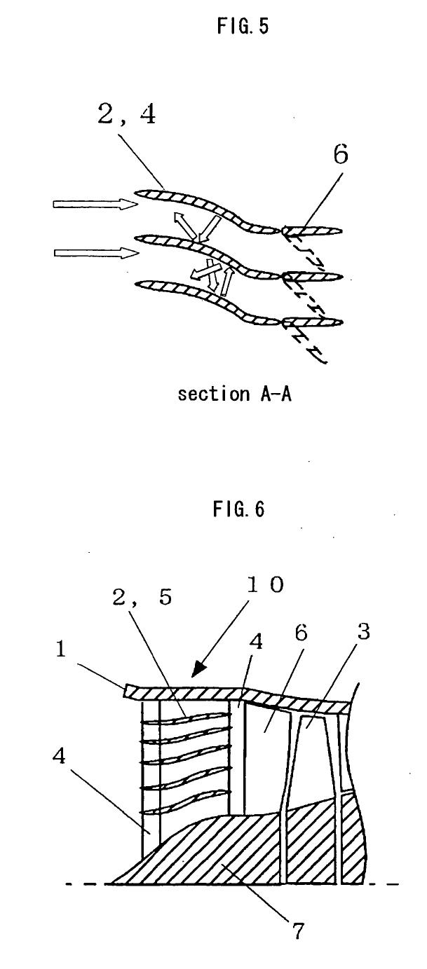

A plurality of struts 4 are disposed at intervals in a peripheral direction to be mounted in the duct and to radially extend around a duct center, whereby the inside of the inlet duct is divided into a plurality of areas in the peripheral direction with respect to a duct center axis. Referring to FIG. 5, the strut 4 is formed into a reflection curved surface shape 2 bent toward a rear end of the engine to block and diffuse a microwave which comes toward the fan moving blade from the inlet duct. In other words, according to the first embodiment, the strut 4 is constructed as a reflection member. Additionally, the strut 4 is formed into the reflection curved surface shape 2 to visually shield the fan moving blade 3 when the turbofan engine 10 is seen from a fan inlet side, and a plurality of struts are arranged at predetermined intervals in the peripheral direction. By this structure, the microwave that enters from the duct inlet is irregularly reflected to be diffused before it enters the fan moving blade 3. If a surface of the strut 4 as the reflection member is made of a radio wave absorber, the microwave that enters the strut 4 is absorbed to a certain extent by the radio wave absorber of the surface. Thus, a better microwave reflection suppression effect can be obtained.

The movable guide vane 6 is a member mounted to a rear end part of the strut 4 to swing around an axial center of a radial direction. The movable guide vane 6 is mounted to each of the plurality of struts. It is to be noted that the movable guide vane 6 is driven to swing by a driving mechanism (not shown). With this configuration, at the time of low trust, the movable guide vane 6 swings around a front end axis to be closed. Thus, the effect of irregularly reflecting and diffusing the microwave can be increased more.

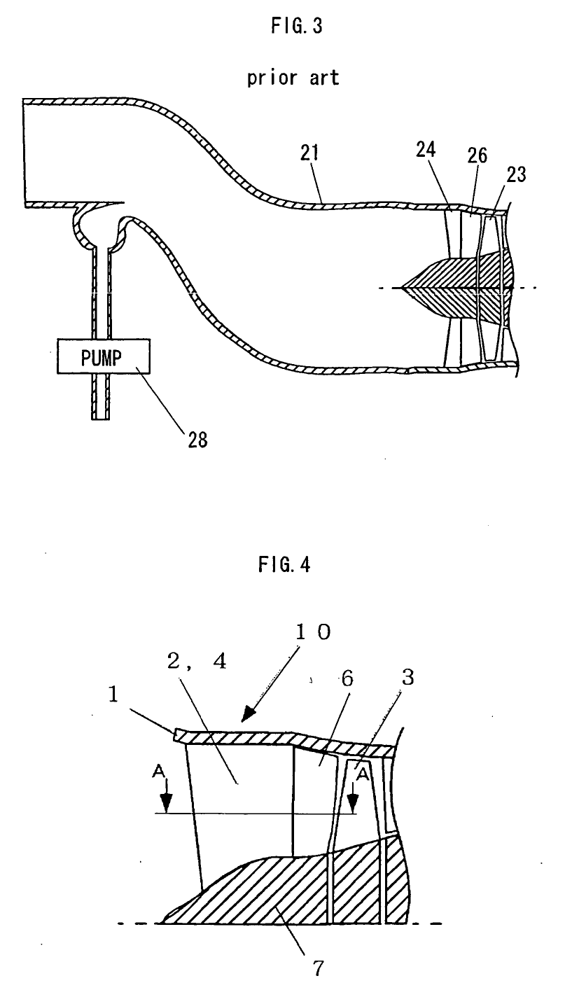

According to the first embodiment, it is possible to obtain the effect of suppressing the reflection of the microwave from the fan moving blade 3 without bending the duct unlike the case of the conventional art shown in FIG. 3. Since the duct is not bent, air separation from the duct during supersonic flight can be suppressed, whereby air can be fed into the fan moving blade 3 by more uniform pressure. As a result, the invention has a good feature of being capable of improving stealthiness and flight performance by compact and minimum components.

Next, the second embodiment of the present invention will be described by referring to FIG. 6.

FIG. 6 is a partial sectional view of a turbofan engine 10 which comprises an apparatus for controlling microwave reflecting according to the second embodiment of the present invention.

Referring to FIG. 6, a strut 4 is divided into front and rear sides, and a peripheral guide vane 5 is fixed therebetween. The strut 4 of the second embodiment is not formed into a reflection curved surface shape 2 similar to that of the strut 4 of the first embodiment. A plurality of peripheral guide vanes 5 are concentrically disposed at intervals in a radial direction to extend in a peripheral direction with respect to a duct center axis, whereby the inside of an inlet duct is divided into a plurality of areas in the radial direction with respect to the duct center axis. The peripheral guide vane 5 is formed into a reflection curved surface shape 2 bent toward a rear end of the engine to block and diffuse a microwave which enters a fan moving blade from the inlet duct. In other words, according to the second embodiment, the peripheral guide vane 5 is constructed as a reflection member. Additionally, the peripheral guide vane 5 is formed into the reflection curved surface shape 2 to visually shield the fan moving blade 3 when the turbofan engine 10 is seen from a fan inlet side, and a plurality of peripheral guide vanes 5 are arranged at predetermined intervals in the radial direction. By this structure, the microwave that enters from a duct inlet 1 is irregularly reflected to be diffused before it enters the fan moving blade 3. If a surface of the peripheral guide vane 5 as the reflection member is made of a radio wave absorber, the microwave that enters the peripheral guide vane 5 is absorbed to a certain extent by the radio wave absorber of the surface. Thus, a better microwave reflection suppression effect can be obtained.

A movable guide vane 6 is similar in configuration to that of the first embodiment. At the time of low trust, the movable guide vane 6 swings around a front end axis to be closed. Thus, the effect of irregularly reflecting and diffusing the microwave can be increased more.

According to the second embodiment, the strut 4 is divided into the front and rear sides. However, an integral configuration in which the strut is not divided into front and rear sides may be employed as long as a structure is capable of fixing and supporting the peripheral guide vane 5.

According to the second embodiment, it is possible to obtain the effect of suppressing the reflection of the microwave from the fan moving blade 3 without bending the duct unlike the case of the conventional art shown in FIG. 3. Since an outer peripheral shape of the duct is not changed, air separation from the duct during supersonic flight can be suppressed, whereby air can be fed into the fan moving blade 3 by more uniform pressure. As a result, the invention has a good feature of being capable of improving stealthiness and flight performance by compact and minimum components.

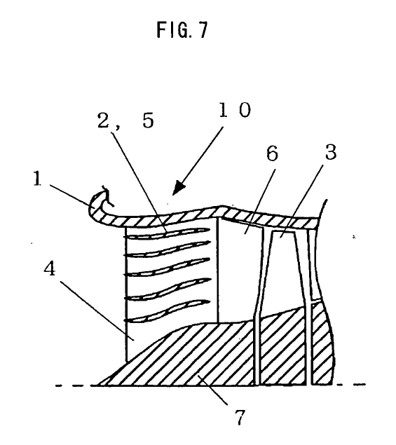

Next, the third embodiment of the present invention will be described by referring to FIG. 7.

FIG. 7 is a partial sectional view of a turbofan engine 10 which comprises an apparatus for controlling microwave reflecting according to the third embodiment of the present invention.

The third embodiment comprises a peripheral guide vane 5 and a movable guide vane 6 similar to those of the second embodiment. In other words, according to the third embodiment, the peripheral guide vane 5 is constructed as a reflection member. A strut 4 of the third embodiment is not formed into a reflection curved surface shape 2 similar to that of the strut 4 of the first embodiment.

By this structure, a microwave that enters from a duct inlet 1 is irregularly reflected to be diffused before it enters a fan moving blade 3. If a surface of the peripheral guide vane 5 as the reflection member is made of a radio wave absorber, the microwave that enters the peripheral guide vane 5 is absorbed to a certain extent by the radio wave absorber of the surface. Thus, a better microwave reflection suppression effect can be obtained.

As shown in FIG. 7, according to the third embodiment, an inner peripheral part of the duct member 1 is formed into a shape along a surface shape of a diameter outside of the peripheral guide vane 5 positioned in an outermost diameter side among a plurality of peripheral guide vanes 5.

The movable guide vane 6 is similar in configuration to that of the first embodiment. At the time of low trust, the movable guide vane 6 swings around a front end axis to be closed. Thus, the effect of irregularly reflecting and diffusing the microwave can be increased more.

According to the third embodiment, it is possible to obtain the effect of suppressing the reflection of the microwave from the fan moving blade 3 without bending the duct unlike the case of the conventional art shown in FIG. 3. Since the duct is not bent, air separation from the duct during supersonic flight can be suppressed, whereby air can be fed into the fan moving blade by more uniform pressure. Moreover, the inner peripheral part of the duct member is formed into the shape along the surface shape of the diameter outside of the peripheral guide vane positioned in the outermost diameter outside, whereby the reflection of the microwave can be more effectively prevented by reducing a microwave entry sectional area of the fan moving blade. As a result, the invention has a good feature of being capable of improving stealthiness and flight performance by compact and minimum components.

According to the foregoing embodiments, the microwave that comes toward the fan moving blade is blocked and diffused by the strut, the peripheral guide vane, the movable guide vane, and the duct outer peripheral shape. Needless to say, however, various changes such as addition of similar functions to other engine components can be made without departing from the scope of the gist of the present invention.

As apparent from the foregoing, according to the present invention, it is possible to obtain the effect of suppressing the reflection of the microwave from the fan moving blade 3 without bending the duct. Since the outer peripheral shape of the duct is not greatly changed, air separation from the duct during supersonic flight can be reduced, whereby air can be fed into the fan moving blade by more uniform pressure. As a result, the invention has a good feature of being capable of improving stealthiness and flight performance by compact and minimum components.

What is claimed is:

1. An apparatus for controlling microwave reflecting comprising:
a reflection member which divides the inside of an inlet duct of a gas turbine engine into a plurality of areas in a peripheral or radial direction with respect to a duct center axis,
wherein the reflection member is formed into a reflection curved surface shape to block and diffuse a microwave which comes toward a fan moving blade from the inlet duct, thereby suppressing reflection of the microwave by the fan moving blade.

2. The apparatus for controlling microwave reflecting according to claim 1, wherein the reflection member comprises a plurality of struts which are mounted in the inlet duct and radially extended around a duct center.

3. The apparatus for controlling microwave reflecting according to claim 1, further comprising a plurality of struts which are mounted in the inlet duct and radially extended around a duct center,
wherein the reflection member comprises a plurality of peripheral guide vanes which are mounted to the struts and which extend in the peripheral direction with respect to the duct center axis and which are concentrically arranged at intervals in a radial direction.

4. The apparatus for controlling microwave reflecting according to claim 3, further comprising a duct member to define the inlet duct,
wherein an inner peripheral part of the duct member is formed into a shape along a surface shape of a diameter outside of a peripheral guide vane positioned in an outermost diameter side among the plurality of peripheral guide vanes.

5. The apparatus for controlling microwave reflecting according to claim 1, further comprising a movable guide vane mounted to a rear end part of the strut to swing around an axial center of the radial direction.

6. The apparatus for controlling microwave reflecting according to claim 2, further comprising a movable guide vane mounted to a rear end part of the strut to swing around an axial center of the radial direction.

7. The apparatus for controlling microwave reflecting according to claim 3, further comprising a movable guide vane mounted to a rear end part of the strut to swing around an axial center of the radial direction.

8. The apparatus for controlling microwave reflecting according to claim 4, further comprising a movable guide vane mounted to a rear end part of the strut to swing around an axial center of the radial direction.

9. The apparatus for controlling microwave reflecting according to claim 1, wherein a surface of the reflection member is made of a radio wave absorber.
